(19) United States
(12) Patent Application Publication
(10) Pub. No.: US 2014/0209084 A1
(43) Pub. Date: Jul. 31, 2014

(54) Camp Fire Set

(71) Applicant: Guy Cole, Tuskahoma, OK (US)

(72) Inventor: Guy Cole, Tuskahoma, OK (US)

(21) Appl. No.: 14/096,337

(22) Filed: Dec. 4, 2013

Related U.S. Application Data
(60) Provisional application No. 61/758,317, filed on Jan. 30, 2013.

(51) Int. Cl. A47J 33/00

(52) U.S. Cl. CPC A47J 33/00
USPC 126/30

(57) ABSTRACT

A portable cooking station device is disclosed that allows users to cook food outside, over a fire, and supports large quantities of food and multiple pots and pans at the same time. The cooking station device comprises a base unit, a pair of vertical poles, and a horizontal bar secured between the pair of vertical poles for retaining cooking equipment. The base unit is configured to be placed directly over a fire pit. The pair of vertical poles are secured to the opposing sides of the base unit, and can comprise hooks for retaining cooking equipment. The horizontal bar can comprise S-shaped hooks for hanging cooking equipment. A rotisserie bar can be secured between the pair of vertical poles, below the horizontal bar, and a grate can be axially attached to one of the vertical poles to allow it to swivel out across the fire pit when in use.

### CROSS-REFERENCE

This application claims priority from Provisional Patent Application Ser. No. 61/758,317 filed Jan. 30, 2013.

### BACKGROUND

When cooking outside or at a campsite, individuals typically have to roast foods on a stick or simply heat up canned food over a fire. This can be unappetizing to some individuals, and can be highly inconvenient if trying to prepare food for a large group of people. An effective solution is necessary.

The present invention provides users with an easy and convenient way to cook food outdoors, and supports large quantities of food and multiple pots, pans, and dishes at the same time. The portable cooking station device enables users to cook for a large group of people without any hassle, and eliminates the need to clean up messes in the kitchen. The device is ideal for anyone who likes to cook outside or at a campsite.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a portable cooking station device that allows users to cook food outside, over a fire, and supports large quantities of food and multiple pots, pans, and dishes at the same time. The cooking station device comprises a base unit, a pair of vertical poles extending upward, and a horizontal bar secured between the pair of vertical poles for retaining cooking equipment. The base unit is hollow and comprises an open top and bottom end, and is configured to be placed directly over a fire pit, or other outdoor cooking area.

The pair of vertical poles are typically removably secured to the opposing sides of the base unit. The vertical poles can comprise at least one hook removably secured to at least one of the pair of vertical poles for retaining cooking equipment or utensils. The horizontal bar is secured between the pair of vertical poles for retaining cooking equipment, such as cooking pots and pans, and other suitable cooking equipment as is known in the art. The horizontal bar can comprise at least one S-shaped hook removably secured to the horizontal bar for hanging cooking equipment therefrom.

In a preferred embodiment, the portable cooking station device comprises a rotisserie bar secured between the pair of vertical poles, below the horizontal bar for roasting pieces of food. The portable cooking station device further comprises at least one grate removably secured to the first end and the second end of the base unit such that the grate spans the interior cavity and is suspended over the fire pit. Additionally, the grate can be axially attached to one of the pair of vertical poles which allows the grate to swivel out across the fire pit when in use.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of the portable cooking station device in accordance with the disclosed architecture.

FIG. 2 illustrates a perspective view of the portable cooking station device with the additional vertical pole and horizontal bar that swivels about the vertical pole in accordance with the disclosed architecture.

FIG. 3 illustrates a top perspective view of the portable cooking station device in use in accordance with the disclosed architecture.

FIG. 4 illustrates a perspective view of the portable cooking station device with the swivel grates in use in accordance with the disclosed architecture.

FIG. 5 illustrates a perspective view of the portable cooking station device with the rotisserie bar in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention provides users with an easy and convenient way to cook food outdoors, and supports large quantities of food and multiple pots, pans, and dishes at the same time. The portable cooking station device enables users to cook for a large group of people without any hassle, and eliminates the need to clean up messes in the kitchen. Anyone who likes to cook outside or at a campsite may appreciate the convenience afforded by this device.

The disclosed portable cooking station device comprises a base unit, a pair of spaced apart vertical poles extending upward, and a repositionable horizontal bar secured between the pair of vertical poles for retaining cooking equipment. The base unit comprises an open top and bottom end, and is configured to be placed directly over a fire pit or other heat source. The pair of vertical poles are preferably secured to the opposing sides of the base unit, and can further comprise hooks for retaining cooking equipment, such as utensils. The horizontal bar can comprise S-shaped hooks for hanging cooking equipment. A rotisserie bar can be secured between the pair of vertical poles, below the horizontal bar for roasting pieces of food, and a grate can be axially attached to one of the vertical poles to allow it to swivel out across the fire pit when in use.

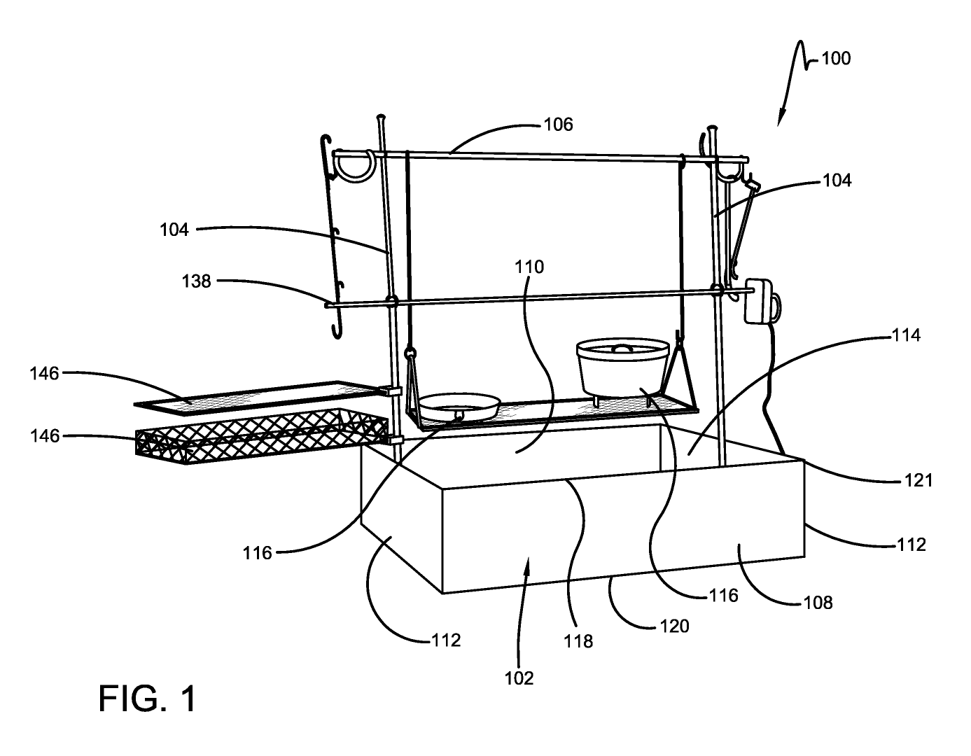

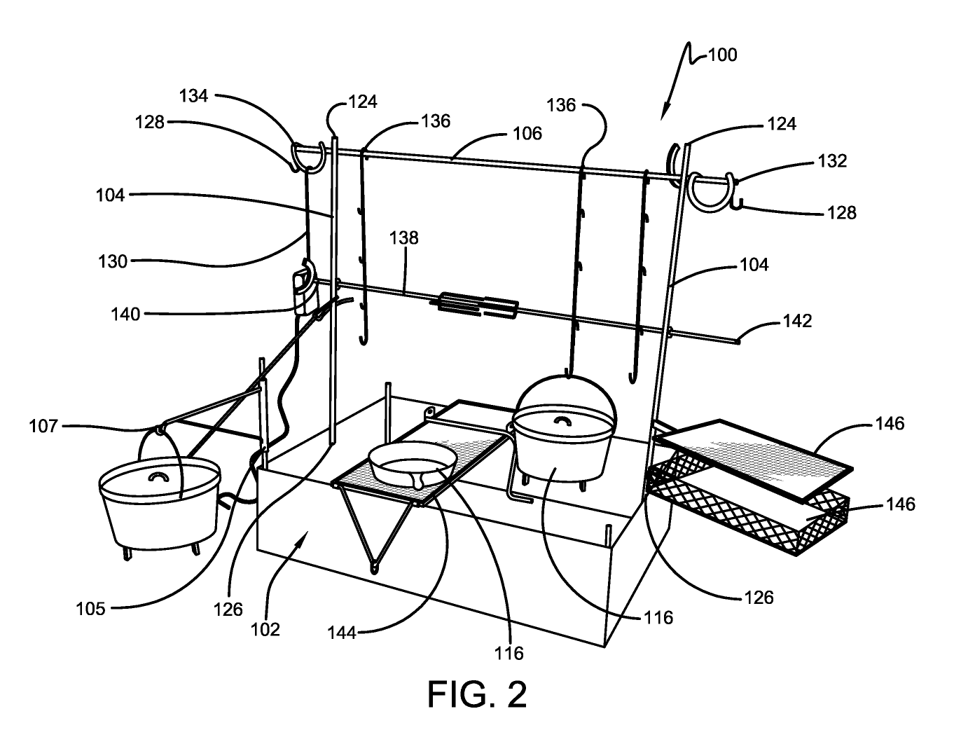

Referring initially to the drawings, FIGS. 1-2 illustrate the portable cooking station device 100 that allows users to cook food outside, over a fire, and supports large quantities of food and multiple pots, pans, and dishes at the same time. The cooking station device 100 comprises a base unit 102, a pair of spaced apart vertical poles 104 extending upward from said base unit, and a horizontal bar 106 secured between the pair of vertical poles 104 for retaining cooking equipment 116 (as shown in FIG. 1).

The base unit 102 comprises a first end 108, a second end 110, opposing sides 112, and an interior cavity 114. Typically, the base unit 102 is rectangular in shape, however any other suitable shape can be used as is known in the art without affecting the overall concept of the invention. The base unit 102 would generally be constructed of iron, carbon steel, stainless steel, etc., though any other suitable material may be used to manufacture the base unit 102 as is known in the art without affecting the overall concept of the invention provided that the same is heat resistant to temperatures of 700° to 1000° Celsius.

The base unit 102 can also comprise a variety of colors and designs to suit user and manufacturing preference. The base unit 102 can be any suitable size as is known in the art, but typically is approximately 3 feet long as measured from the first end 108 to the second end 110, and approximately 46.5 inches wide as measured from opposing sides 112, and approximately 12 inches thick as measured from a front surface 118 to a back surface 120.

Typically, the base unit 102 is hollow and comprises an open top and bottom end. Thus, the base unit 102 is configured to be placed directly over a fire pit 122, or other outdoor cooking area, and is heat resistant. However, the base unit 102 does not have to be hollow and can function by being partly solid, as long as a substantial amount of heat can be ducted through the interior cavity 114 of the base unit 102 to cook food.

The portable cooking station device 100 further comprises a pair of spaced apart and substantially vertical poles 104 which are generally parallel to one another. The vertical poles 104 extend upward from the base unit 102 and are secured to the opposing sides 112 of the base unit 102. The vertical poles 104 comprise a top end 124 and a bottom end 126, and are typically cylindrical in shape, however any other suitable shape can be used as is known in the art without affecting the overall concept of the invention. The vertical poles 104 would generally be constructed of iron, steel, stainless steel, aluminum, etc., though any other suitable material may be used to manufacture the vertical poles 104 as is known in the art without affecting the overall concept of the invention provided that the same is heat resistant to temperatures of 700° to 1000° Celsius.

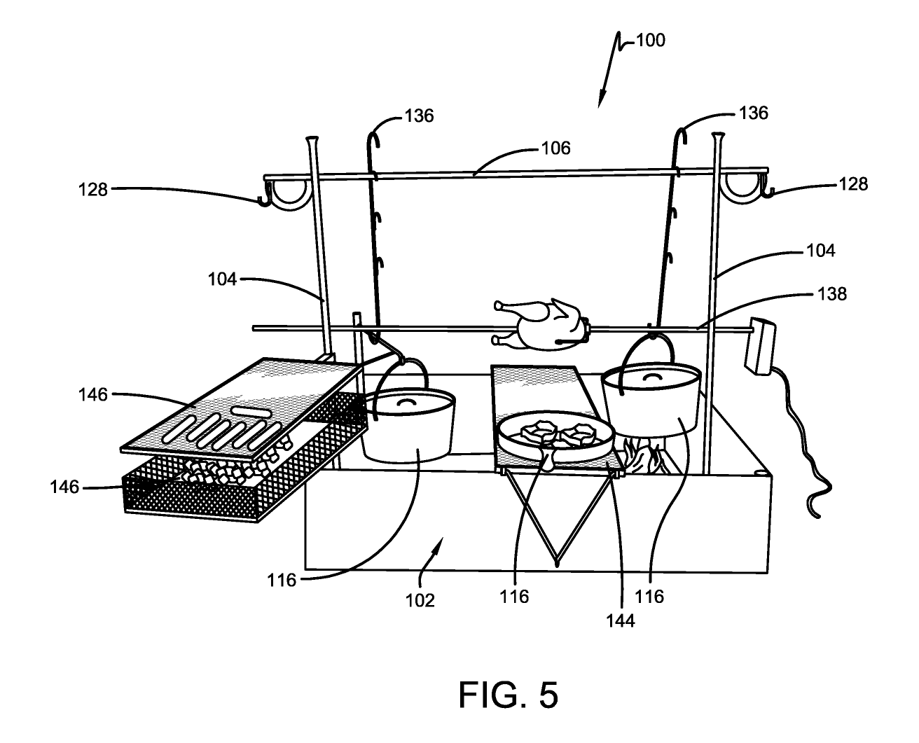

The vertical poles 104 can also comprise a variety of colors and designs to suit user and manufacturing preference. The vertical poles 104 can be any suitable size as is known in the art but are typically approximately 57 inches long as measured from the top end 124 to the bottom end 126, and approximately ¾ inches in diameter. The portable cooking station device 100 comprises at least a pair of substantially vertical poles 104, however any suitable number of vertical poles 104 can be used as is known in the art without affecting the overall concept of the invention. For example, an additional vertical pole 105 can be removably secured to a corner 121 of the base unit 102 and a substantially horizontal pole 107 can be axially attached to an end of the additional vertical pole 105 via a pinned connection or other suitable attachment means. Thus, the pinned connection allows the horizontal pole 107 to swivel out across the fire pit 122 when in use, as shown in FIG. 5 and explained more fully below.

The pair of vertical poles 104 are typically removably secured to the opposing sides 112 of the base unit 102 or the corners 121 (or any other suitable position on the base unit 102) via being inserted into a small pocket or other insertion on the base unit 102. Further the pair of vertical poles 104 can be secured to the opposing sides 112 of the base unit 102 via any suitable means as is known in the art, such as welding, gluing, fasteners, etc., as long as the securing means is heat resistant. The vertical poles 104 can further comprise at least one hook 128 removably secured to at least one of the pair of vertical poles 104 for retaining cooking equipment 130 such as utensils and the like. The hook 128 can be any suitable hook as is known in the art, and is typically just hung from the ends 124 or 126 of the vertical poles 104 to retain cooking equipment 130. Typically, the cooking equipment 130 comprises at least one of a fire poker, cooking utensils, etc.

The portable cooking station device 100 further comprises a horizontal bar 106 secured between the pair of vertical poles 104 for retaining cooking equipment 116, such as cooking pots and pans, and other suitable cooking equipment as is known in the art. The horizontal bar 106 comprises a first end 132 and a second end 134, and is typically cylindrical in shape, however any other suitable shape can be used as is known in the art without affecting the overall concept of the invention. The horizontal bar 106 would generally be constructed of iron, steel, stainless steel, aluminum, etc., though any other suitable material may be used to manufacture the horizontal bar 106 as is known in the art without affecting the overall concept of the invention provided that the same is heat resistant to temperatures of 700° to 1000° Celsius.

The horizontal bar 106 can also comprise a variety of colors and designs to suit user and manufacturing preference. The horizontal bar 106 can be any suitable size as is known in the art but is typically approximately 59 inches long as measured from the first end 132 to the second end 134, and approximately ¾ inches in diameter. The portable cooking station device 100 comprises at least one horizontal bar 106, however any suitable number of horizontal bars 106 can be used as is known in the art without affecting the overall concept of the invention.

The horizontal bar 106 is typically removably secured between the pair of vertical poles 104 via being inserted into a small pocket or other insertion on the end 124 or 126 of the vertical poles 104. Further the horizontal bar 106 can be secured to the vertical poles 104 via any suitable means as is known in the art, such as welding, gluing, fasteners, etc., as long as the securing means is heat resistant. The horizontal bar 106 can further comprise at least one S-shaped hook 136 removably secured to the horizontal bar 106 for hanging cooking equipment 116. The S-shaped hook 136 comprises multiple hooks secured at various lengths of the S-shaped hook 136 to allow for a user to hang the cooking equipment 116 or whatever is hung from the hook 136 at different heights from the fire. The S-shaped hook 136 can be any suitable hook as is known in the art, and is typically just hung from the horizontal bar 106 to retain cooking equipment 116. Typically, the cooking equipment 116 comprises at least one of a cooking pot, a cooking pan, etc.

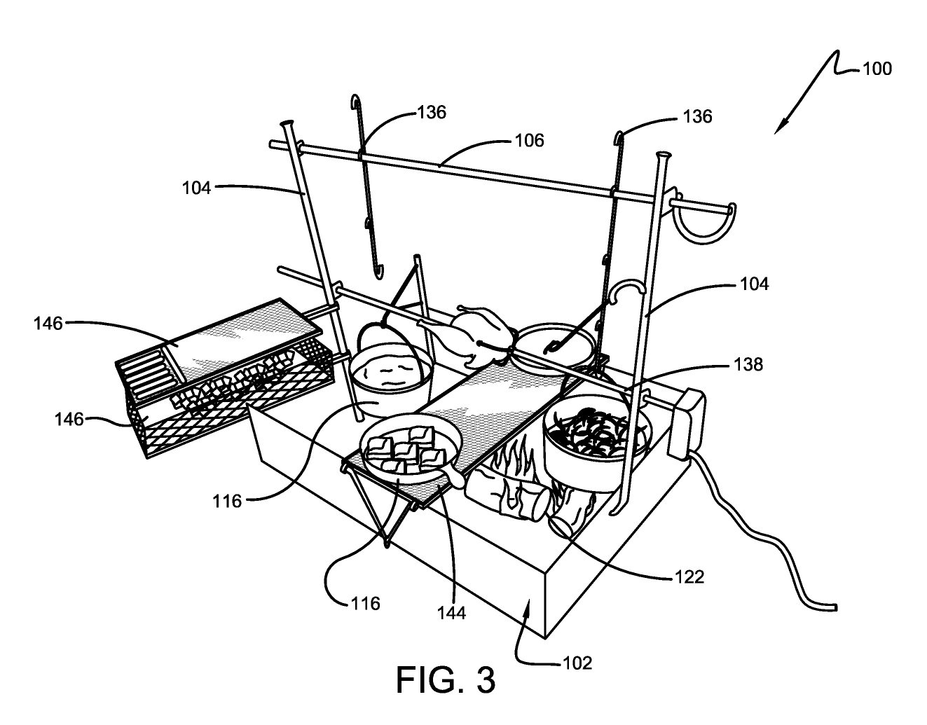

Furthermore, the portable cooking station device 100 comprises a rotisserie bar 138 secured between the pair of vertical poles 104, below the horizontal bar 106 for roasting pieces of food (as shown in FIG. 3). The rotisserie bar 138 is typically positioned closer to the fire or heat source than the horizontal bar 106, but can be positioned at any suitable position between the vertical poles 104 as is known in the art. The rotisserie bar 138 comprises a first end 140 and a second end 142, and is typically cylindrical in shape, however any other suitable shape can be used as is known in the art without affecting the overall concept of the invention. The rotisserie bar 138 would generally be constructed of iron, steel, stainless steel, aluminum, etc., though any other suitable material may be used to manufacture the rotisserie bar 138 as is known in the art without affecting the overall concept of the invention provided that the same is heat resistant to temperatures of 700° to 1000° Celsius.

The rotisserie bar 138 can also comprise a variety of colors and designs to suit user and manufacturing preference. The rotisserie bar 138 can be any suitable size as is known in the art but is typically approximately 60 inches long as measured from the first end 140 to the second end 142, and approximately ½ inches in diameter. The portable cooking station device 100 comprises at least one rotisserie bar 138, however any suitable number of rotisserie bars 138 can be used as is known in the art without affecting the overall concept of the invention.

The rotisserie bar 138 is typically removably secured between the pair of vertical poles 104 via being inserted into a small pocket or other insertion on the end 124 or 126 of the vertical poles 104. Further the rotisserie bar 138 can be secured to the vertical poles 104 via any suitable means as is known in the art, such as welding, gluing, fasteners, etc., as long as the securing means is heat resistant. The rotisserie bar 138 is adjustable and either has a hand crank or an electric motor for turning the bar 138 and rotating the food over the fire.

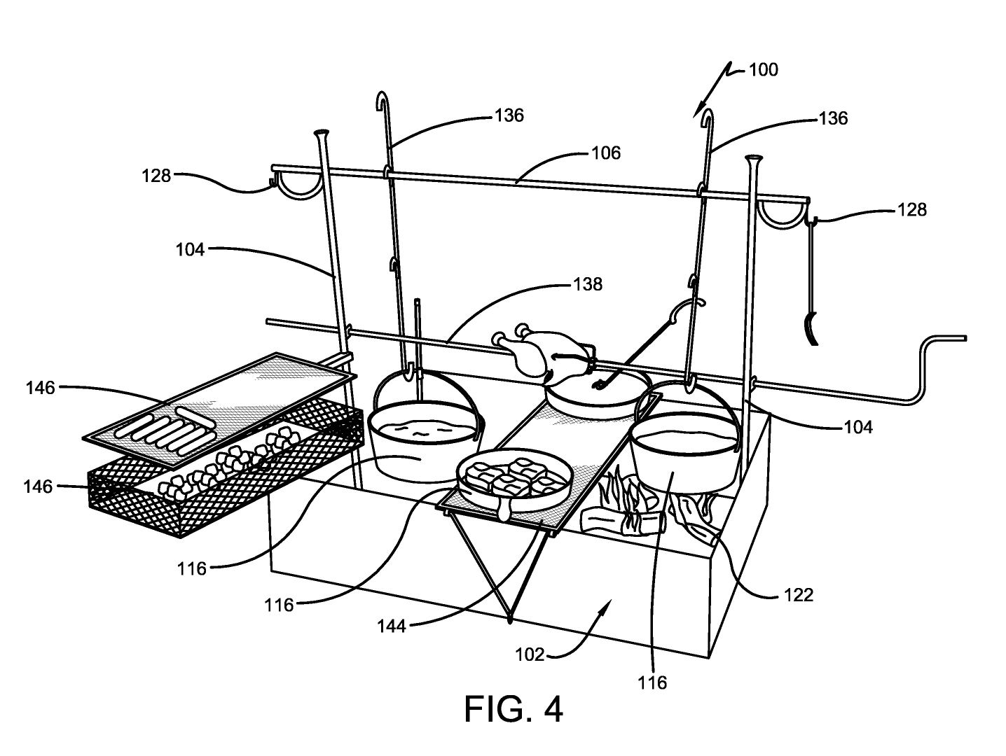

The portable cooking station device 100 further comprises at least one grate 144 removably secured to the first end 108 and the second end 110 of the base unit 102 such that the grate 144 spans the interior cavity 114 and is suspended over the fire pit 122 (as shown in FIG. 4). The grate 144 can be any suitable size or shape as is known in the art, as long as it spans the interior cavity 114 and can hold food for grilling or pots and pans, etc. Typically, the grate 144 is just set on the base unit 102, spanning the interior cavity 114 and resting on the ends 108 and 110. However, the grate 144 can be secured to the base unit 102 via any suitable securing means as is known in the art, such as welding, gluing, fasteners, etc., as long as the securing means is heat resistant. The grate 144 is typically constructed of the same materials as base unit 102, such as iron, steel, stainless steel, aluminum, etc., though any other suitable material may be used to manufacture the grate 144 as is known in the art without affecting the overall concept of the invention provided that the same is heat resistant to temperatures of 700° to 1000° Celsius.

Additionally, the portable cooking station device 100 comprises at least one grate 146 that is secured to one of the pair of vertical poles 104. The grate 146 is axially attached to one of the pair of vertical poles 104 via a pinned connection or other suitable securing means as is known in the art. Thus, the pinned connection allows the grate 146 to swivel out across the fire pit 122 when in use (as shown in FIG. 2). Any suitable number of grates 146 can be secured to the vertical poles 104 as is known in the art. The grate 146 can be any suitable size or shape as is known in the art, as long as it can hold food for grilling or pots and pans, etc. The grate 146 is typically constructed of the same materials as base unit 102, such as iron, steel, stainless steel, aluminum, etc., though any other suitable material may be used to manufacture the grate 146 as is known in the art without affecting the overall concept of the invention provided that the same is heat resistant to temperatures of 700° to 1000° Celsius.

FIGS. 3-5 illustrate the portable cooking station device 100 in use. In operation, a user (not shown) would choose the size and/or amount of horizontal bars 106 and/or rotisserie bars 138 that meets their needs and/or wants. The user would then place the base unit 102 directly over the fire pit 122 and would secure the vertical poles 104 to the opposing sides 112 of the base unit 102. The user would then secure the desired horizontal bars 106 and/or rotisserie bars 138 on the vertical poles 104, in the desired positions.

The user can then attach the desired number of grates 144 to the vertical poles 104 and swivel the grates 144 over the fire pit 122 as needed. The user can then secure any number of S-shaped hooks to the horizontal bar 106 for hanging cooking equipment, such as cooking pots and pans, and can secure hooks to the vertical poles 104 for hanging a fire poker, cooking utensils, etc. Once the desired about of horizontal bars 106, rotisserie bars 138, and grates 144 are secured in the desired positions, the user can ignite the fire in the fire pit 122 and begin to cook using the portable cooking station 100 to grill and cook the food at the same time.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A portable cooking station device comprising:
a base unit comprising a first end, a second end, opposing sides, and an interior cavity;
a pair of vertical poles extending upward from and secured to the opposing sides of the base unit; and
at least one horizontal bar secured between the pair of vertical poles for retaining cooking equipment.

2. The portable cooking station device of claim 1, wherein the base unit comprises an open top and bottom end, and is configured to be placed directly over a fire pit.

3. The portable cooking station device of claim 2, further comprising a rotisserie bar secured between the pair of vertical poles, below the horizontal bar.

4. The portable cooking station device of claim 2, further comprising at least one grate removably secured to the first end and the second end of the base unit such that the grate spans the interior cavity and is suspended over the fire pit.

5. The portable cooking station device of claim 2, further comprising at least one grate that is secured to one of the pair of vertical poles.

6. The portable cooking station device of claim 5, wherein the at least one grate is axially attached to one of the pair of vertical poles such that the at least one grate can swivel about said one of the pair of vertical poles and out across the fire pit when in use.

7. The portable cooking station device of claim 2, further comprising at least one hook removably secured to at least one of the pair of vertical poles for retaining cooking equipment.

8. The portable cooking station device of claim 7, wherein the cooking equipment comprises at least one of a fire poker or cooking utensils.

9. The portable cooking station device of claim 2, further comprising at least one S-shaped hook removably secured to the horizontal bar for hanging cooking equipment.

10. The portable cooking station device of claim 9, wherein the cooking equipment comprises at least one of a cooking pot or a cooking pan.

11. The portable cooking station device of claim 2, further comprising at least one additional vertical pole removably secured to a corner of the base unit and a substantially horizontal pole secured to an end of the at least one additional vertical pole.

12. The portable cooking station device of claim 11, wherein the substantially horizontal pole is axially attached to the at least one additional vertical pole such that the substantially horizontal pole can swivel out across the fire pit when in use.

13. A portable cooking station device comprising:
a base unit comprising a first end, a second end, opposing sides, and an interior cavity;
a pair of spaced apart vertical poles extending upward from and secured to the opposing sides of the base unit;
at least one horizontal bar secured between the pair of spaced apart vertical poles for retaining cooking equipment; and
a rotisserie bar secured between the pair of spaced apart vertical poles, below the horizontal bar; and
wherein the base unit comprises an open top and bottom end, and is configured to be placed directly over a fire pit.

14. The portable cooking station device of claim 13, further comprising at least one grate removably secured to the first end and the second end of the base unit such that the grate spans the interior cavity and is suspended over the fire pit.

15. The portable cooking station device of claim 13, further comprising at least one grate that is secured to one of the pair of spaced apart vertical poles.

16. The portable cooking station device of claim 15, wherein the at least one grate is axially attached to one of the pair of spaced apart vertical poles such that the at least one grate can swivel about said one of the pair of spaced apart vertical poles and out across the fire pit when in use.

17. The portable cooking station device of claim 13, further comprising at least one hook removably secured to at least one of the pair of spaced apart vertical poles for retaining cooking equipment.

18. The portable cooking station device of claim 13, further comprising at least one S-shaped hook removably secured to the horizontal bar for hanging cooking equipment.

19. A portable cooking station device comprising:
a base unit comprising a first end, a second end, opposing sides, and an interior cavity;
a pair of spaced apart vertical poles extending upward from and secured to the opposing sides of the base unit;
at least one horizontal bar secured between the pair of spaced apart vertical poles for retaining cooking equipment; and
a rotisserie bar secured between the pair of spaced apart vertical poles, below the horizontal bar; and
wherein the base unit comprises an open top and bottom end, and is configured to be placed directly over a fire pit; and
at least one grate that is axially attached to one of the pair of spaced apart vertical poles such that the at least one grate can swivel about said one of the pair of spaced apart vertical poles and out across the fire pit when in use.

20. The portable cooking station device of claim 19, further comprising at least one S-shaped hook removably secured to the horizontal bar for hanging cooking equipment.
